(19) United States
(12) Patent Application Publication
(10) Pub. No.: US 2007/0040842 A1
(43) Pub. Date: Feb. 22, 2007

(54) Buffer memory system and method

(75) Inventor: Keiichiro Ishihara, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Winbond Electronics Corp

(21) Appl. No.: 11/453,091

(22) Filed: Jun. 15, 2006

(30) Foreign Application Priority Data
Aug. 17, 2005 (JP) 2005-236673

(51) Int. Cl. G09G 5/36

(52) U.S. Cl. 345/545

(57) ABSTRACT

A method is provided for use in a buffer memory system having at least one buffer memory to process image data of an image frame. The method may include writing a first plurality of lines of the image data to the buffer memory in a first writing sequence; reading the first plurality of lines of the image data from the buffer memory in a first reading sequence; and writing a second plurality of lines of the image data, before completing the reading of the first plurality of lines, to the buffer memory in a second writing sequence different from the first writing sequence.

### CROSS REFERENCE

This application is based upon and claims the benefit of priority from the prior Japanese Patent Application No. 2005-236673, filed on Aug. 17, 2005, the entire contents of which are incorporated herein by reference.

### TECHNICAL FIELD

This disclosure relates generally to buffer memory technologies and, more particularly, to buffer memory systems for raster-to-block conversion in image signal encoding systems.

### BACKGROUND

Digital images may be represented by image data on a line-by-line or pixel-by-pixel basis, also known as raster scan. Such image data may be called raster-sequence image data. However, image signal processing systems, such as image signal encoding systems, may use image processing transform algorithms on a block-by-block basis. Raster-to-block conversion may be used to convert raster-sequence image data in order to provide block signal data to such image processing transform algorithms.

Certain image signal processing systems use a double buffer memory system which include two identical buffer memories. An address circuit is also provided to generate addresses for writing and reading to/from the two buffer memories. During operation of the double buffer memory system, a certain number of lines of raster-sequence image signals of a frame of an image are written into the first buffer memory. The certain number of lines of raster-sequence image signals then are read out of the first buffer memory block-by-block to perform raster-to-block conversion.

At the same time of the reading operation, a second same number of lines of raster-sequence image signals are written into the second buffer memory. After the completion of reading from the first buffer memory, the second buffer memory may be ready to be read out while the first buffer memory is ready for writing the next, or the third, same number of lines of raster-sequence image signals. The first buffer memory and the second buffer memory are thereby used in turns for reading and writing until all raster-sequence image signals of the frame of the image are processed.

Although the conventional double buffer memory systems provide fast raster-to-block conversions, two large-capacity high-speed buffer memories are often required. Therefore, the conventional double buffer memory systems may often have a large size and/or a high cost. In certain image processing applications, such large size and/or high cost may make the conventional double buffer memory systems undesirable and/or impractical.

Methods and systems consistent with certain features of the disclosed systems are directed to solving one or more of the problems set forth above.

### SUMMARY OF THE INVENTION

One aspect of the present disclosure includes a method for use in a buffer memory system having at least one buffer memory to process image data of an image frame. The method may include writing a first plurality of lines of the image data to the buffer memory in a first writing sequence; reading the first plurality of lines of the image data from the buffer memory in a first reading sequence; and writing a second plurality of lines of the image data, before completing the reading of the first plurality of lines, to the buffer memory in a second writing sequence different from the first writing sequence.

Another aspect of the present disclosure includes a buffer memory system for use in processing of image data of an image frame. The buffer memory system may include at least one buffer memory configured to store the image data and a control section. The control section may be configured to generate addresses for writing and reading the image data to and from the buffer memory. The addresses may be generated for writing a first plurality of lines of the image data to the buffer memory in a first writing sequence; for reading the first plurality of lines of the image data from the buffer memory in a first reading sequence; and for writing a second plurality of lines of the image data, before completing the reading of the first plurality of lines, to the buffer memory in a second writing sequence different from the first writing sequence.

### BRIEF DESCRIPTION OF THE DRAWINGS

FIG. 1 illustrates an exemplary buffer memory system consistent with certain disclosed embodiments;

FIG. 2 illustrates an exemplary buffer memory consistent with certain disclosed embodiments;

FIG. 3 illustrates an exemplary buffer memory segment consistent with certain disclosed embodiments; and

FIG. 4 illustrates an exemplary operational sequence of the buffer memory system consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

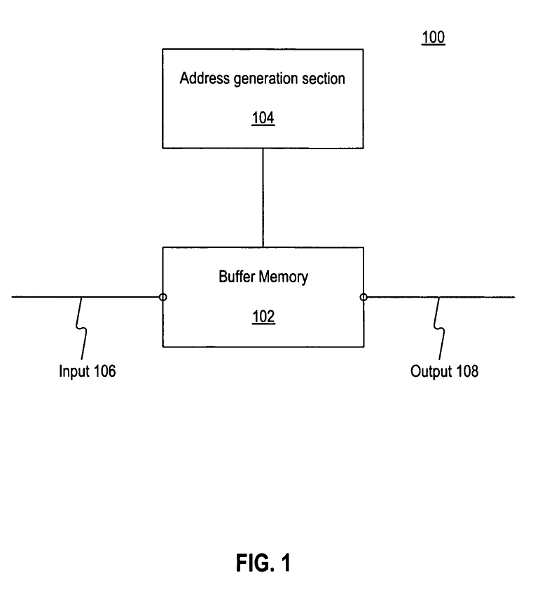

FIG. 1 shows an exemplary buffer memory system 100. As shown in FIG. 1, buffer memory system 100 may include a buffer memory 102, an address generation section 104, an input 106, and an output 108. The numbers and types of devices are exemplary only, different numbers and/or types of devices may also be used.

Input 106 may include any appropriate type of input that may provide raster-sequence image signals (i.e., raster-sequence image data) to buffer memory 102 for writing operations of buffer memory 102. For example, input 106 may include a data bus of appropriate width to provide raster-sequence image signals to be stored in buffer memory 102 based on addresses generated by address generation section 104. Other types of input, however, may also be used. Raster-sequence image signals may include line-by-line sequence image data and each line of sequence image data may be called a raster line. Raster lines of raster-sequence image signals may be sequentially written to or stored in buffer memory 102 through input 106.

The stored raster-sequence image signals may be read out from buffer memory 102 in a block-by-block order through output 108 based on addresses generated by address generation section 104. Output 108 may include any appropriate type of output that may provide converted block image signals (i.e., block image data) to an outside device in a reading operation or a series of reading operations. For example, output 108 may include a data bus of appropriate width to provide block image signals to certain external devices (not shown) coupled to buffer memory 102. Other types of output, however, may also be used.

Address generation section 104 may include any appropriate type of logic device or control device for generating addresses for reading and writing operations of buffer memory 102. Address generation section 104 may also include appropriate logic to implement address calculation algorithms to dynamically determine addresses for reading and/or writing based on operational status of buffer memory 102. Address generation section 104 may also be controlled by an external controller (not shown), such as a processor, to generate addresses for reading and/or writing operations of buffer memory 102. Further, address generation section 104 may generate addresses for a reading operation during a writing operation of buffer memory 102, or may generate addresses for a writing operation during a reading operation of buffer memory 102.

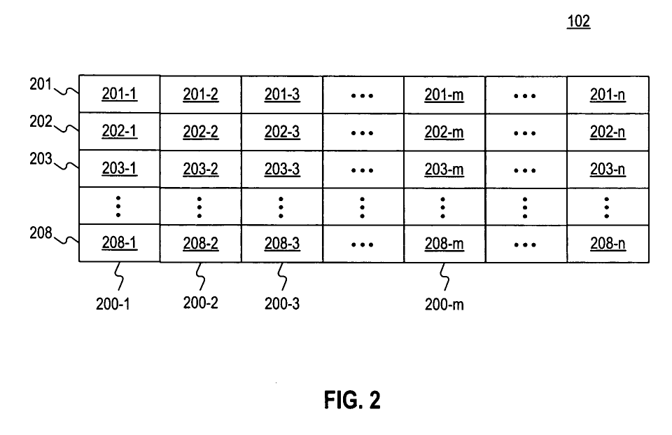

Buffer memory 102 may include any appropriate type of memory for use in image processing applications. FIG. 2 shows an exemplary configuration of buffer memory 102. As shown in FIG. 2, buffer memory 102 may be configured in a line-by-line structure. For example, buffer memory 102 may be configured to include pixel lines 201, 202, 203, . . . , and 208, for a total of 8 pixel lines. Other numbers of pixel lines, however, may also be used. Each of pixel lines 201-208 may include a sequence of pixel cells. A pixel cell may be one byte (e.g., 8 bits) of memory. The sequence of pixel cells may be accessed for writing and/or reading operations based on addresses generated by address generation section 104.

The addresses for accessing (e.g., write and/or read) the sequence of pixel cells may be, for example, sequentially increased from left to right among pixel cells of a single pixel line and/or from top to bottom among different pixel lines, as shown in FIG. 2. Other type of addressing configuration, however, may also be used.

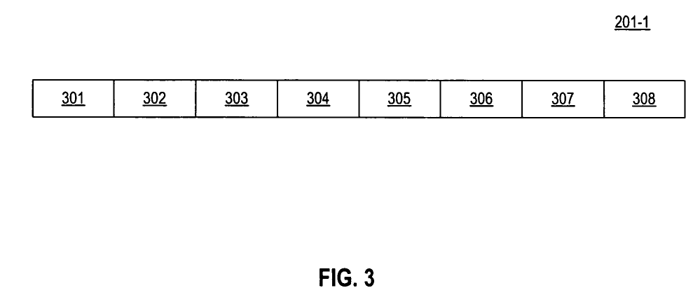

Each of pixel lines 201-208 may also be represented by a sequence of pixel segments, with each pixel segment having a predetermined number of pixel cells (e.g., 8 pixel cells). For example, pixel line 201 may include pixel segments 201-1, 201-2, 201-3, . . . , 201-m, . . . , and 201-n, for a total of n pixel segments. Also, as shown in FIG. 3, each pixel segment (e.g., pixel segment 201-1) may include 8 pixel cells, such as pixel cells 301, 302, 303, 304, 305, 306, 307, and 308.

Further, the number “n” may represent the length of pixel lines, in term of a total number of pixel segments in a pixel line (n), or a total number of pixel cells (n×8). The number “m”, on the other hand, may represent a length of a raster line of raster-sequence image signals of a particular frame of image in an image processing application. The raster line may be written into pixel line 201 (pixel segments 201-1 to 201-m). The length of the raster line may also be represented in terms of a total number of pixel segments in a pixel line (m), or a total number of pixel cells (m×8). For the purpose of simplicity, n may be greater than or equal to m such that a pixel line may be long enough to hold a raster line of a particular image frame.

The total size of buffer memory 102 may be calculated as the total number of pixel lines multiplied by the total number pixel cells per pixel line (e.g., 8×n×8=64×n pixel cells). On the other hand, the total size of actual used memory may be calculated as the total number of pixel lines multiplied by the total number pixel cells per raster line (e.g., 8×m×8=64×m pixel cells). Address generation section 104 may determine proper addresses for reading and/or writing operations based on the total size of buffer memory 102 and/or the total size of actual used memory. In one embodiment, m and n may be the same.

When buffer memory 102 is used in image signal processing systems, such as image signal encoding systems, raster-to-block conversion may be performed by using buffer memory 102. For example, image signal encoding systems may use image transform algorithms, such as 2D discrete cosine transform (2D-DCT), to perform MPEG video compressions or JPEG image compressions that are based on block-by-block image data. To convert the sequential raster-sequence image data of an image frame, raster-sequence image signals of an image frame may be stored in buffer memory 102 line-by-line and the stored image signals may be read from buffer memory 102 block-by-block. Each block of image signals may be referred to as a pixel block and may be of a rectangle, square, or any block shape.

The size of a pixel block may be predetermined according to particular image processing applications. In one embodiment, the pixel block size may be 8 pixels×8 pixels. A pixel block may be stored in buffer memory 102 in a memory block. For example, as shown in FIG. 2, memory blocks 200-1, 200-2, 200-3, . . . , 200-m may each include corresponding pixel segments from respective pixel lines of raster-sequence image signals. Memory block 200-1 may include first pixel segments 201-1, 202-1, 203-1, . . . , and 208-1 of respective pixel lines 201, 202, 203, . . . , and 208; memory block 200-2 may include second pixel segments 201-2, 202-2, 203-2, . . . , and 208-2 of respective pixel lines 201, 202, 203, . . . , and 208; and so on. Because, for exemplary purposes, each pixel segment includes eight pixel cells and eight lines of raster-sequence image signals are written to buffer memory 102, each of memory blocks 200-1, 200-2, 200-3, . . . , and 200-m is of a size of 8 pixels×8 pixels and may hold a pixel block of the image signals.

The raster-sequence image signals stored in a memory block may be read out as a pixel block for purpose of raster-to-block conversion. For example, FIG. 2 shows a corresponding square (8×8) shaped memory block for storing data of a pixel block. However, the data of the pixel block may also be stored anywhere in buffer memory 102 so long as the pixel block may be formed when reading out the data of the pixel block.

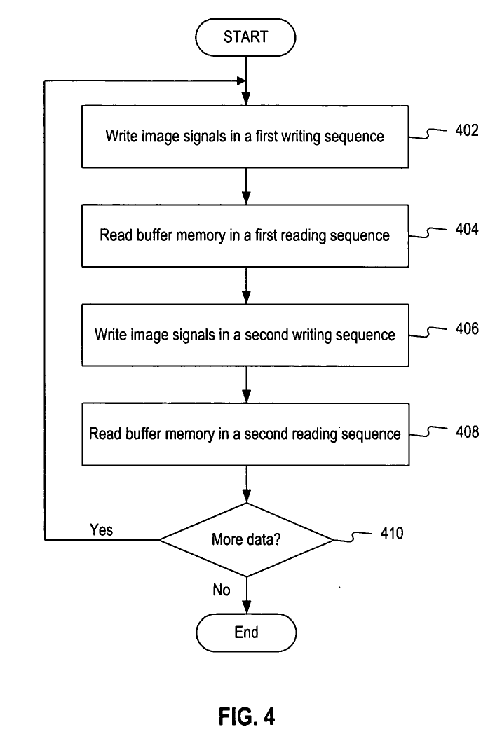

During a raster-to-block conversion operation, raster-sequence image signals may be written into buffer memory 102, for example, in pixel lines 201, 202, 203, . . . , and 208. The raster-sequence image signals may then be read out by or provided to output 108 in a block-by-block order, for example, in the order of memory blocks 200-1, 200-2, 200-3, . . . , and 200-m. Such writing and/or reading operations may be based on addresses generated by address generation section 104. FIG. 4 shows exemplary writing and reading operations for raster-to-block conversion operations.

As shown in FIG. 4, at the beginning of raster-to-block conversion, raster-sequence image signals may be written into buffer memory 102 in a first writing sequence based on addresses generated by address generation section 104 (step 402). Raster-sequence image signals may be written to buffer memory 102 in a line-by-line order. For example, the first line of raster-sequence image signals may be sequentially written into pixel segments 201-1, 201-2, 201-3, . . . , and 201-m (assuming the length of the line is m, as explained above). Similarly, the second line of raster-sequence image signals may be written into pixel segments 202-1, 202-2, 202-3, . . . , and 202-m, and so on. The writing operation for the first eight lines of raster-sequence image signals may be complete after the eighth line of raster-sequence image signals has been sequentially written into segments 208-1, 208-2, 208-3, . . . , and 208-m.

After the first eight lines of raster-sequence image signals are written into buffer memory 102, the reading operation for raster-to-block conversion may start. The raster-sequence image signals stored in buffer memory 102 may be read out by or provided to output 108 in a first reading sequence (step 404). For example, pixel blocks may be read out sequentially, starting from memory block 200-1, then memory block 200-2, and so on, until last memory block 200-m is read out.

After a memory block has been read out during the reading operation of the first eight lines of raster-sequence image signals, that memory block may be available to commence the writing operation for a second eight lines of raster-sequence image signals of the image frame under processing. Address generation section 104 may generate addresses for writing raster-sequence image signals in a second writing sequence (step 406).

In the second writing sequence, an individual line of the second eight lines of raster-sequence image signals may be written into buffer memory 102 based on available memory blocks. For example, if the reading operation of memory block 200-1 has been completed with respect to the first eight lines of raster-sequence image signals, the first line of the second eight lines of raster-sequence image signals may be written to memory block 200-1. That is, the first line of raster-sequence image signals may be written to pixel segments 201-1, 202-1, 203-1, . . . , and 208-1. For convenience of explanation, assuming m has a value of 8, the first line of raster-sequence image signals may be completely written to memory block 200-1. Similarly, during the reading operation of buffer memory 102, the remainder of the second eight lines of raster-sequence image signals may be written to other memory blocks. For example, the second line of the second eight lines of raster-sequence image signals may be written into pixel segments 201-2, 202-2, 203-2, . . . , and 208-2, and so on.

During or after writing operations for the second eight lines of raster-sequence image signals (step 406), address generation section 104 may generate addresses to read out the second eight lines of raster-sequence image signals in a second reading sequence (step 408). The second eight lines of raster-sequence image signals may be read out in a particular order such that corresponding segments of the respective lines of raster-sequence image signals may be read out sequentially to form pixel blocks. In the example above, assuming m is 8, pixel segments 201-1, 201-2, 201-3, . . . , and 201-8 (i.e., first segments of the second eight respective lines of raster-sequence image signals) may be read out to form a first pixel block; pixel segments 202-1, 202-2, 202-3, . . . , and 202-8 may be read out to form a second pixel block; and so on.

Further, during or after the reading operations of the second lines of raster-sequence image signals, address generation section 104 may, either automatically or under control of external controllers, decide whether there are more lines of raster-sequence image signals to be converted (step 410). If there are more lines of raster-sequence image signals to be converted, address generation section 104 may continue generating addresses for more raster-to-block conversion operations (e.g., writing and reading operations, etc.) from step 402. On the other hand, if all lines of raster-sequence image signals of the image frame have been converted, address generation section 104 may complete the writing and reading operations.

As explained above, address generation section 104 may generate addresses for the writing and/or reading operations. Address generation section 104 may generate the addresses based on predetermined address calculation algorithms. For example, address generation section 104 may calculate or update addresses for writing operations as follows:
temp_addr_{—}w=addr_{—}w+incr_{—}w; and
addr_{—}w=(temp_addr_{—}w% hpix)+(temp_addr_{—}w/hpix) (1);
where addr_w is a writing address generated for writing operation; hpix is the length of a pixel line in terms of the number of pixel cells; incr_w is an incremental value to be added to a current writing address in order to derive a next or updated writing address; and temp_addr_w is an intermediate variable used for updating addr_w; “%” is an integer modulo operator; and “/” is an integer division operator.

Further, address generation section 104 may also calculate or update addresses for reading operations as follows:
temp_addr_{—}r=addr_{—}r+incr_{—}r; and
addr_{—}r=(temp_addr_{—}r% hpix)+(temp_addr_{—}r/hpix) (2);
where addr_r is an address generated for reading operation; temp_addr_r is an intermediate variable used for updating addr_r; and incr_r is an incremental value to be added to a current reading address in order to derive a next or updated reading address.

Address generation section 104 may initialize the terms in the equations above. For example, address generation section 104 may initialize addr_w=0; addr_r=0; incr_w=1; and incr_r=hpix/8.

Address generation section 104 may generate writing addresses to store a first predetermined lines (e.g., 8 lines) of raster-sequence image signals in buffer memory 102 (e.g., pixel lines 201-208). As explained above, this writing sequence may also be referred to as the first writing sequence. After all eight lines of image signals are written to buffer memory 102, address generation section 104 may change the incremental value incr_w to be the same as addr_r to be ready for writing the next eight lines of image signals in the second writing sequence. At the same time, the first reading sequence may be started to read out the stored image data block-by-block.

After the first eight lines of image data are read out, address generation section may change the incremental value incr_r as follows to be ready for reading the next eight lines of image signals stored in buffer memory 102 in the second reading sequence:
temp_incr=incr_{—}r×hpix/8 (3); and
incr_{—}r=(temp_incr % hpix)+(temp_incr/hpix) (4);
where temp_incr is an intermediate variable used for updating incr_r.

Further, the above equations (1)-(4) may be simplified to be more suitable for certain hardware devices or logics. For example, if the maximum value of writing address is assumed to be less than hpix, equation (1) may be simplified as:

if (temp_addr_w < hpix)
{addr_w = temp_addr_w}
else
{addr_w = temp_addr_w − hpix + 1}

Equation (2) may also be simplified as:

if (temp_addr_r < hpix)
{addr_r = temp_addr_r}
else
{addr_r = temp_addr_r − hpix + 1}

In addition, the calculation of the incremental value incr_r may also simplified. For example, by combining equations (3) and (4), the incremental value incr_r may be calculated as:

$$\begin{matrix}incr\_r = ( ( incr\_r \times hpix / 8 ) \% hpix ) + ( ( incr\_r \times hpix / 8 ) / hpix ) \\ = ( ( incr\_r \times hpix / 8 ) \% hpix ) + ( incr\_r / 8 )\end{matrix} \qquad ( 8 )$$

Further, incr_r×hpix may be calculated as:

$$\begin{matrix}incr\_r \times hpix = hpix \times \{ ( incr\_r \%8 ) + ( incr\_r / 8 ) << 3 \} \\ = hpix \times ( incr\_r \%8 ) + hpix \times \{ ( incr\_r / 8 ) << 3 \} \\ = hpix \times ( incr\_r \%8 ) + \{ hpix \times ( incr\_r / 8 ) \} << 3\end{matrix}$$

Therefore,
incr_{—}r×hpix/8=hpix×(incr_{—}r% 8)/8+hpix×(incr_{—}r/8).
In addition, because hpix×(incr_r/8) is an integer multiple of hpix, (incr_r×hpix/8)% hpix may be calculated as:
(incr_{—}r×hpix/8)% hpix=hpix×(incr_{—}r% 8)/8.
Thus, equation (5) may be further simplified as:
incr_{—}r=((incr_{—}r% 8)×hpix/8)+(incr_{—}r/8).

Because incr_r may be calculated by using division by 8 and residue arithmetic using a multiplier circuit and an adder/subtractor circuit, without having a large number of arithmetic circuits. That is, address generation section 104 may be implemented by one multiplier and one adder/subtractor.

It is intended that the specification and examples be considered as exemplary only. Other embodiments of the invention will be apparent to those skilled in the art from consideration of the specification and practice of the invention disclosed herein.

What is claimed is:

1. A method for use in a buffer memory system having at least one buffer memory to process image data of an image frame, comprising:
writing a first plurality of lines of the image data to the buffer memory in a first writing sequence;
reading the first plurality of lines of the image data from the buffer memory in a first reading sequence; and
writing a second plurality of lines of the image data, before completing the reading of the first plurality of lines, to the buffer memory in a second writing sequence different from the first writing sequence.

2. The method according to claim 1, further comprising:
reading the second plurality of lines of the image data from the buffer memory in a second reading sequence different from the first reading sequence.

3. The method according to claim 2, wherein:
the first writing sequence includes storing the image data in a line-by-line order; and
the first reading sequence includes reading out the image data in a block-by-block order.

4. The method according to claim 3, wherein:
the second writing sequence includes storing a line of the second plurality of lines of the image data in a memory block that has been read by the first reading sequence.

5. The method according to claim 4, further including:
providing the memory block to have a size of 8 pixels by 8 pixels.

6. The method according to claim 2, wherein addr_w is a writing address, hpix is a length of each line of the first plurality of lines and the second plurality of lines, incr_w is an incremental value for updating the writing address, and temp_addr_w is an integer, the first writing sequence and the second writing sequence using writing addresses calculated by
temp_addr_{—}w=addr_{—}w+incr_{—}w; and
addr_{—}w=(temp_addr_{—}w% hpix)+(temp_addr_{—}w/hpix).

7. The method according to claim 2, wherein addr_r is a reading address, hpix is a length of each line of the first plurality of lines and the second plurality of lines, incr_r is an incremental value for updating the reading address, and temp_addr_r is an integer, the first reading sequence and the second reading sequence using reading addresses calculated by
temp_addr_{—}r=addr_{—}r+incr_{—}r; and
addr_{—}r=(temp_addr_{—}r% hpix)+(temp_addr_{—}r/hpix).

8. A buffer memory system for use in processing of image data of an image frame, comprising:
at least one buffer memory configured to store the image data; and
a control section configured to generate addresses for writing and reading the image data to and from the buffer memory, wherein the addresses are generated for:
writing a first plurality of lines of the image data to the buffer memory in a first writing sequence;
reading the first plurality of lines of the image data from the buffer memory in a first reading sequence; and
writing a second plurality of lines of the image data, before completing the reading of the first plurality of lines, to the buffer memory in a second writing sequence different from the first writing sequence.

9. The buffer memory system according to claim 8, wherein the control section is further configured to generate the addresses for:
reading the second plurality of lines of the image data from the buffer memory in a second reading sequence different from the first reading sequence.

10. The buffer memory system according to claim 9, wherein the control section is configured to generate the addresses such that:
the first writing sequences stores the image data in a line-by-line order; and
the first reading sequence reads out the image data in a block-by-block order.

11. The buffer memory system according to claim 10, wherein the control section is configured to generate the addresses such that:
the second writing sequence stores a line of the second plurality of lines of the image data in a memory block that has been read by the first reading sequence.

12. The buffer memory system according to claim 11, wherein:
the memory block has a size of 8 pixels by 8 pixels.

13. The buffer memory system according to claim 9, wherein addr_w is a writing address, hpix is a length of each line of the first plurality of lines and the second plurality of lines, incr_w is an incremental value for updating the writing address, and temp_addr_w is an integer, the control section calculating writing addresses for the first writing sequence and the second writing sequence by
temp_addr_{—}w=addr_{—}w+incr_{—}w; and
addr_{—}w=(temp_addr_{—}w% hpix)+(temp_addr_{—}w/hpix).

14. The buffer memory system according to claim 9, wherein addr_r is a reading address, hpix is a length of each line of the first plurality of lines and the second plurality of lines, incr_r is an incremental value for updating the reading address, and temp_addr_r is an integer, the control section calculating reading addresses for the first reading sequence and the second reading sequence by
temp_addr_{—}r=addr_{—}r+incr_{—}r; and
addr_{—}r=(temp_addr_{—}r% hpix)+(temp_addr_{—}r/hpix).

15. The buffer memory system according to claim 8, wherein the control section includes a multiplier circuit and an adder/subtractor circuit configured to generate the addresses for writing and reading the image data.
